(19) United States
(12) Patent Application Publication
(10) Pub. No.: US 2024/0065814 A1
(43) Pub. Date: Feb. 29, 2024

(54) Novel Dental Impression Tray for Easy Release of Dental Stone Models

(71) Applicants: Victor Quartey, Halifax (CA); Lee Babin, Halifax (CA)

(72) Inventors: Victor Quartey, Halifax (CA); Lee Babin, Halifax (CA)

(21) Appl. No.: 18/237,454

(22) Filed: Aug. 24, 2023

Related U.S. Application Data
(60) Provisional application No. 63/474,629, filed on Aug. 31, 2022.

(51) Int. Cl. A61C 9/00

(52) U.S. Cl. CPC A61C 9/0006

(57) ABSTRACT

A dental impression tray having a plurality of adjoining segments forming an entirety thereof. A hinge is optionally provided between each of the adjoining segments allowing movement of the segments relative to each other. Each of the segments has slots therein. Removable stiffening elements are used for selectively locking and unlocking the hinges, during the use thereof for taking a dental impression, and for removing a stone model therefrom respectively. The tray optionally comprises one or more hinges. The stiffening elements and the slots have a moment of inertia to resist bending stress. Because of the hinges and the stiffening elements, there is no possibility of lateral movement of one segment relative to the other. The lateral guiding of the segments prevents, to a great extent, any deformation in the dental stone model when the tray is manipulated with a strong hand grip.

### FIELD OF THE INVENTION

The present invention relates to a novel dental impression tray system. More particularly, the invention relates to a segmented dental impression tray that is designed to facilitate the removal of hardened dental models therefrom.

### BACKGROUND

The current invention has applications to the field of dentistry and tooth impression practices.

Dentists are required to make impressions of patients' dentitions in many standard dental procedures. Common practice is to use a rigid (plastic or metal) impression tray that is filled with an impression material before being placed onto the patient's teeth, allowing the teeth to form an imprint in the impression material. After the impression material sets on the teeth, the solidified impression provides a negative cavity of the patient's teeth and gums. A plaster like material with a hardener is then mixed and poured into the negative cavity and allowed to harden. The dental plaster material is often referred to as stone or dental stone.

Upon hardening, the dental stone forms a positive three-dimensional replica of the patient's dentition. In order for this hardened stone model to be used, the stone model has to be separated from the impression material. The impression material at this point is firmly adhered to the dental tray. This separation is effected manually, and in many cases is exceptionally tedious. By nature, teeth assume a variety of shapes and present with divergent angles to each other along numerous planes. Thus, when the stone model cures, it becomes mechanically locked inside of the negative impression cavity. Removal of the stone model from the tray can be difficult and many models are damaged in the process, irreversibly losing precious detail and accuracy.

Dental stone material is very hard and brittle while cured, yet also very easy to break while uncured. Due to these properties, it is common for dentists or dental workers to schedule the removal of the stone model from the impression tray at the perfect time because: (a) if one removes the stone model too early prior to full stone set, important features in the stone will break off the model, (b) if one removes the stone model too late, the impression material becomes overly stiff and doesn't have enough flexibility, leading again the fracturing of the dental model (or impossibility of its retrieval without soaking the entire tray for hours in water). However, even if one removes the stone model at the correct time, the divergent angles of the teeth in the model often cause the stone model to fracture. At the very least, the stone model is often difficult and time-consuming to remove. This removal process often requires the worker to, either individually or in combination: (a) physically strike the stone model with a rigid object to break engaging areas of the stone model off the impression, (b) pries the dental stone from the impression with a lab knife and/or (c) to attempt to cut or scrape impression material away from between the stone and the tray to give some more room to manipulate the model. The above points are particularly true when using alginate-type impression materials.

The breaking of a stone model is an unfortunate event for the dentist, denturist, or the patient. Depending on the break, it is common for the dentist to try to glue the pieces back together, which can result in misalignment and error. If the patient needs to be brought back in to repeat the impression process, time and money is lost and patient confidence can diminish.

Because current impression trays (both metal and plastic) are rigid, one-piece trays, the above-mentioned problems are common occurrences in the field of dentistry. The rigid tray does not provide anywhere near the flexibility of the cured impression material in the tray, thus greatly adding to the chances of stone breakage during separation of the model from the set impression material. The separation of the model from the set material can cause many features of the stone to break, most often resulting in stone teeth remaining in the set impression material.

Another reason for such frequent damage of dental stones during the removal of the stones from impression trays can be explained as follows. Structurally, dental models assume a U-shaped form along the occlusal plane thereof. The most vulnerable stresses that can be applied to that structure are forces along the occlusal plane, such as a forceful manipulation tending to close the legs of the U-shaped structure of the stone. This occurs often during separation of the stone from the impression material.

The prior art in this field discloses various improvements in the field of dental impression trays. For example:
US Patent 53,347 issued to G.F. Schaffer on Mar. 20, 1866, discloses a palatal tray that can be taken apart in segments.
US Patent 310,407 issued to A. Garner on Jan. 6, 1885, discloses the use of flat tabs sliding in sleeves to retain cup extension onto a dental impression tray.
U.S. Pat. No. 7,125,251 issued to Lydie Livolsi on Oct. 24, 2006, discloses an impression tray that has segments separated by hinges.
U.S. Pat. No. 8,360,772 issued to Evan McCarthy on Jan. 29, 2013, discloses the use of T-slots to retain segments of a dental tray together, to accommodate different impressions.
WO 97/10771, published by Bernard Nepault on Mar. 27, 1997, discloses an extendable contour-type tray that uses sliding flat rods movable in sleeves

The dental trays of the prior art have had limited commercial success. Although improvements to impression trays have been made in the past, none of these improvements address the present difficulties to remove a stone model from an impression tray without applying any stress to the stone model along the occlusal and/or other planes.

Therefore, a need exists for a novel impression tray capable of easily and reliably releasing the impression material after the stone model has set, without the possibility of damaging the stone model.

### BRIEF DESCRIPTION OF THE DRAWINGS

The embodiments of the present invention are not limited by the accompanying drawings, in which like numerals denote like elements.

FIG. 1 depicts an exploded view of a segmented impression tray, the first tray, according to the first embodiment of the present invention, with the stiffener bars removed.

FIG. 2 depicts an isometric side, end, and bottom view of the first tray shown in FIG. 1, with the stiffener bars installed.

FIG. 3 depicts a top view of the first tray as shown in FIGS. 1-2.

FIG. 4 depicts a side view of the first tray as shown in FIGS. 1-3.

FIG. 5 is a perspective top view of the stiffener bars used to lock the segments of the first tray.

FIG. 6 is a bottom perspective view of the stiffener bars in FIG. 5.

FIG. 7 is a perspective side, top and rear view of the first tray showing the stone model set in the impression material.

FIG. 8 is a side view of the first tray in FIG. 7.

FIG. 9 is a side view of the first tray in FIG. 8, with the stiffener bars removed.

FIG. 10 is a side view of the first tray showing the segments thereof hinged away from each other to expose and release the impression material and the stone model therefrom.

FIG. 11 is a photograph of the first tray showing a perspective front, side, and top view thereof.

FIG. 12 is a photograph of the first tray showing a side view thereof.

FIG. 13 is a photograph of the first tray showing a top view thereof.

FIG. 14 is a photograph of the first tray showing a bottom view thereof.

FIG. 15 illustrates an exploded view of the second tray according to the second embodiment of the present invention.

FIG. 16 is a side view of the second tray.

### SUMMARY OF THE INVENTION

In a first embodiment of the present invention, there is provided a segmented dental impression tray herein referred to as the first impression tray. The first impression tray is made of two or more slotted segments hinged to each other and one or more removable stiffening elements that interface with the slots in the segments of the tray. The stiffening elements act to selectively restrict the rotation of the segments relative to each other. When the stiffening elements are installed, the segments are held together, forming a seamless tray. When the stiffening elements are removed, the segments are free to rotate relative to one another, about their respective hinges.

More specifically, the first impression tray comprises:
a plurality of adjoining segments forming an entirety thereof, each of the segments having one or more slots therein;
a hinge means between each of the adjoining segments allowing the segments to rotate relative to each other about the center axis of the hinge means; and
stiffening elements inserted into the segment slots for selectively locking and unlocking the segments together.

The slots in the segments are tapered along the length of the slot, beginning with a larger cross-sectional area and ending in a smaller cross-sectional area. The hinge means may take different forms, such as a built-in hinge, also called a live hinge, that is molded into the tray.

The stiffening elements may also take different forms, but in all cases, the stiffening elements are designed to ensure the tray resists bending stress and to restrict the rotation of the tray segments. For example, the tray may use stiffener bars designed to removably, fitly slide in the segment slots for selectively locking and unlocking the segments in place. Alternatively, instead of stiffener bars, the first impression tray can incorporate tension rods, threaded, or otherwise designed for tightening, which extend through the segments and pull the segments together when the tension rods are tightened. The stiffening elements optionally have a handle or similar means that enable their insertion and removal from the segment slots.

Furthermore, the stiffening elements and the segment slots have a moment of inertia to resist bending stress along the occlusal plane of the tray and in planes at right angles to said plane. This ensures that the segments are tightly held together during the use of the tray for taking a dental impression, and that the segments can be carefully manipulated during the removal of the stone model from the tray.

In a second embodiment of the present invention, a second dental impression tray is provided. This second impression tray is made of two or more segments, and optionally has separable hinges connecting the segments to each other. When used, the hinges allow for rotation of the segments of the tray relative to each other and also restrict movement of the segments on a plane transverse to the axis of the hinges. Stiffening elements, such as stiffener bars or tension rods, threaded or otherwise designed for tightening, extend through the segments, and pull the segments together when the tension rods are tightened. When installed, the stiffening elements restrict the rotation of the segments. The removal of the stiffening elements allows rotation of the segments.

More specifically, the second impression tray comprises:
a plurality of adjoining segments forming an entirety thereof, wherein the segments may be discrete or be identifiable by a thinning of the material adjoining the segments, and wherein the segments each have one or more slots therein;
stiffening elements removably extending through the segment slots for selectively locking the segments during the use thereof for taking a dental impression, and unlocking the segments during the removal of a stone model therefrom.
said stiffening elements removably extending through one or more of the segments yet engaging by means of a locking feature into the last segment;
said locking feature in the last segment comprising, for example, but not limited to, threads, a friction fit, a detent, a separate nut, or a cotter pin.

Optionally, said second impression tray has hinges, optionally having hinge pins, between each of the adjoining segments, allowing the segments to rotate relative to each other about the center axis of each hinge. If used, said hinge pins snap into a corresponding saddle in the adjoining segment, the diameter of the hinge pins being slightly larger than the opening in the saddle, allowing for rotation about the central axis of each hinge pin but preventing translation. Furthermore, each of the hinges has engaging shoulders there along. These shoulders are configured for preventing a movement of the segments along any axes of the hinges. In addition, the tension rods are configured for pulling the flanges of the segments against each other, ultimately increasing the resistance to bending in the occlusal plane. Alternatively, a simple a hinge can be used, such as a hinge formed by a depression increasing the malleability of the material in that area.

Both the first and second impression trays are partly or entirely made of, but not limited to; all tray materials commonly used in the dental field: including, but not limited to, metals, plastics, silicones or rubbers. For example, the tray components may be made from thermosetting polymers, thermoplastic polymers, rubbers, or a plurality of these materials, and are components manufactured by means of injection molding, additive manufacturing, subtractive manufacturing or a mixture of these methods.

Furthermore, both the first and second impression trays are designed for use either on the upper jaw or the lower jaw. The tray for the lower jaw allows room for the tongue to fit between the two sides of the tray. Trays for the upper and lower jaw otherwise have the same features, including the slotted segments, stiffener bars, and optional hinges.

In a third aspect of the present invention, a third impression tray is provided. This third tray can be made according to the descriptions of the first or second tray, thereby being made of two or more segments with an optional hinge means and stiffening elements. In contrast to the first and second trays, the third tray features dissolvable segments or parts, or can be entirely dissolvable. The dissolvable segments or parts are dissolved in a specified solution, the composition of which depends on the composition of the dissolvable parts. The dissolvable tray allows for greater degrees of freedom and manipulation of the tray in nearly any dimension, thereby easing the separation of the dental model. The third tray can also be made for either the upper jaw or the lower jaw.

In all three described impression trays, deflection along the occlusal plane and virtually any other plane is limited during the manipulation of the trays while stiffener bars or tension rods are in the tray.

This brief summary has been provided so that the nature of the invention may be understood quickly. A more complete understanding of the invention can be obtained by reference to the following detailed description of the embodiments thereof, in connection with the attached drawings.

### DETAILED DESCRIPTION

The terminology used herein is for the purpose of describing particular embodiments only and is not intended to be limiting of the invention. As used herein, the term “and/or” includes any and all combinations of one or more of the associated listed items. As used herein, the singular forms “a”, “an” and “the” are intended to include the plural forms as well as the singular forms, unless the context clearly indicates otherwise. It will be further understood that the terms “comprises” and/or “comprising”, when used in this specification, specify the presence of stated features, steps, operations, elements and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of steps and techniques are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New teeth impression devices, apparatuses, and methods for removing impression and dental stone from impression trays are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figure or description below. The drawings presented herein are presented for convenience to explain the function of the elements in the different embodiments of the present invention. These drawings are not fabrication drawings, and should not be scaled.

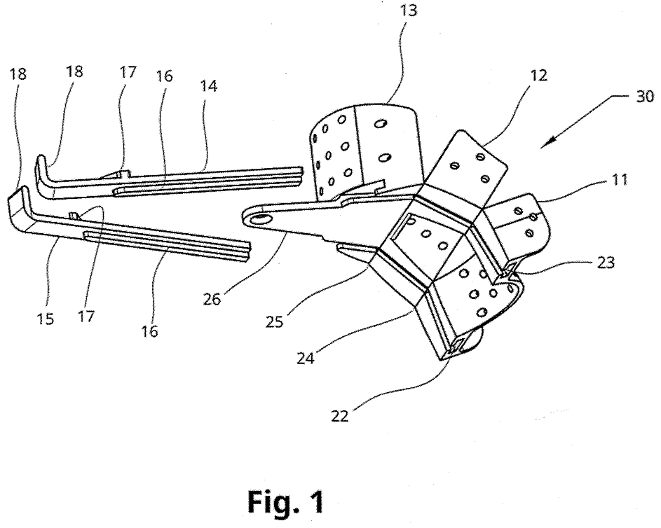

The present invention will now be described by referencing the appended figures representing different embodiments. FIG. 1 depicts an exploded view of the impression tray according to the first embodiment of the present invention. In this impression tray, there are two stiffener bars 14 and 15, that are slidably engageable into respective slots 22 and 23 along the tray 30. Stiffener bars 14 and 15, which may have various cross-sectional shapes, may be free to run in corresponding slots 22 and 23 or engage in some or all of the slots 22 and 23 by various means, such as, but not limited to, threads, friction fit, half-turn latch, or detents. The stiffener bars 14 and 15 can alternatively be tension rods that operate in the same way as the stiffener bars.

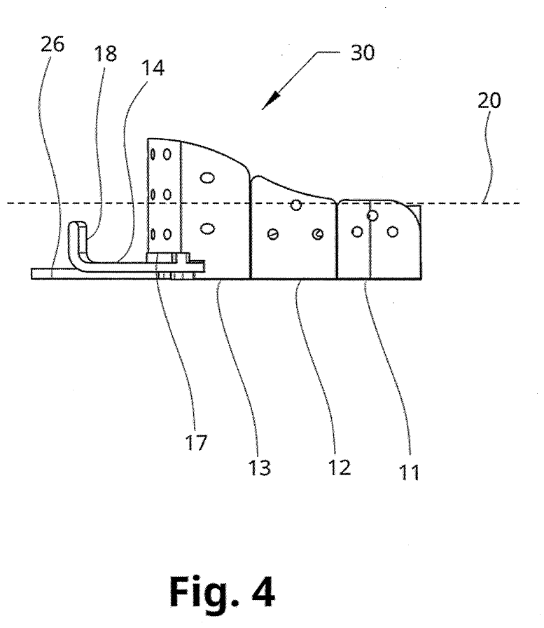

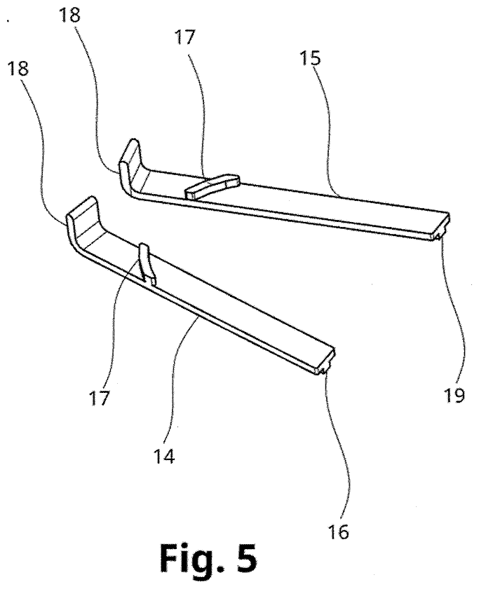

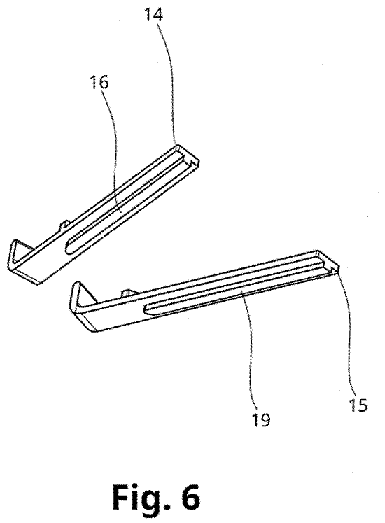

In this first tray, the stiffener bars 14 and 15 are “T” shaped bars with a cross section that has a wide top and an underside ridge 16. It is understood that the shape of the stiffener bars is not limited to the “T” shape and could be other shapes, including but not limited to: rectangular, triangular, square, X-shaped or I-beam shaped (that is with top and bottom flanges and a center web). The goal of the stiffener bars is to increase the moment of inertia in any direction normal to the longitudinal axis thereof. The stiffener bars improve stiffness of the impression tray along the occlusal plane 20 of the tray as shown in FIG. 4. Stiffener bars, regardless of the shape, may have a taper that starts from the handle end resulting in a larger cross-sectional area at the handle end and a smaller cross-sectional area at the opposing end. Said stiffener bar taper will be between 0° and 5°. Stiffener bars 14 and 15 have indexing bumpers 17 that limit their insertion in their respective slots, by contacting the front surface of the first tray 30. In other embodiments, the indexing bumpers may be captured, retained, or otherwise restricted from axial movement when the stiffener bars are inserted fully into slots 22 and 23, by features that are integrated into segment 13. The stiffener bars 14 and 15 and the first impression tray 30 are preferably made from plastics or metals. The engagement of the stiffener bars 14 and 15 into respective slots 22 and 23 is a precise sliding fit. The slots 22 and 23 may taper in the same direction as the stiffener bars 14 and 15, with a taper between 0° and 5° along their respective lengths. As described earlier, the stiffener bars can be replaced with a different stiffening element, such as tension rods, to achieve the same goal.

The first tray has three segments, 11, 12, 13, that are hinged to each other. It is understood that the tray can alternatively be made with two segments, three segments, four segments, five segments, or more than five segments. As shown in the example of the first tray in FIG. 1, segment 11 is connected to segment 12 by hinge 24 and segment 12 is connected to segment 13 by hinge 25. Both hinges are formed of a long and narrow crease in the bottom surface of the tray, such as the spine of a book. Such a crease or spine affords bending there along but no lateral displacement of the adjoining parts along its axis.

It will be appreciated that because of the hinge structure and the stiffener bars or alternative stiffening elements, there is no possibility of lateral movement of one segment relative to another during the manipulation of the impression tray 30 with a strong hand grip. There is no possibility of damaging the stone model by applying too much force against the U-shaped structure of the stone model, at least when the stone model is still in the tray.

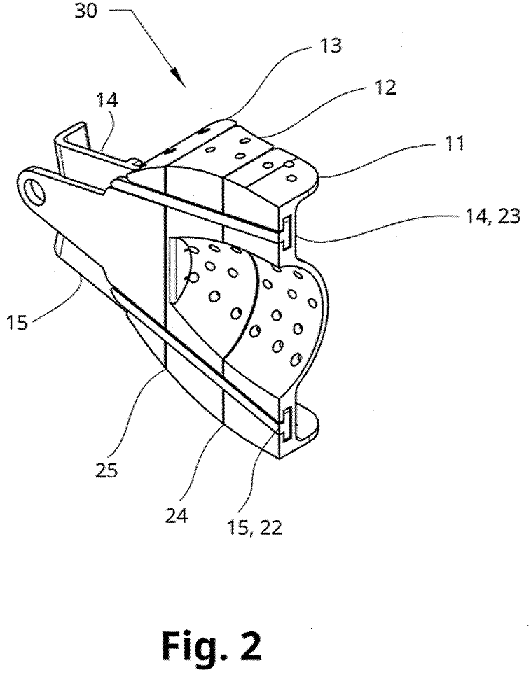

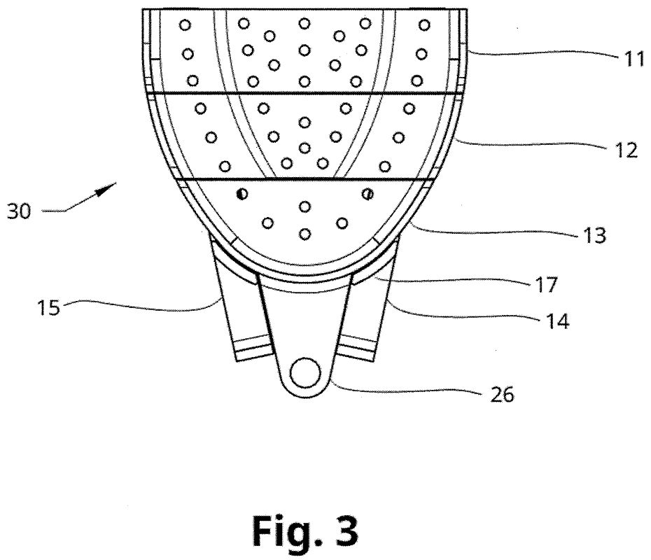

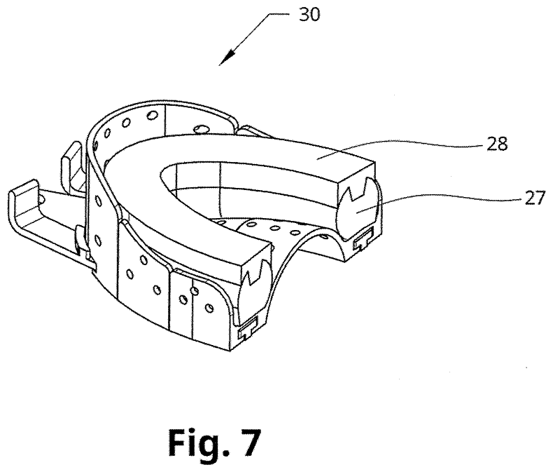

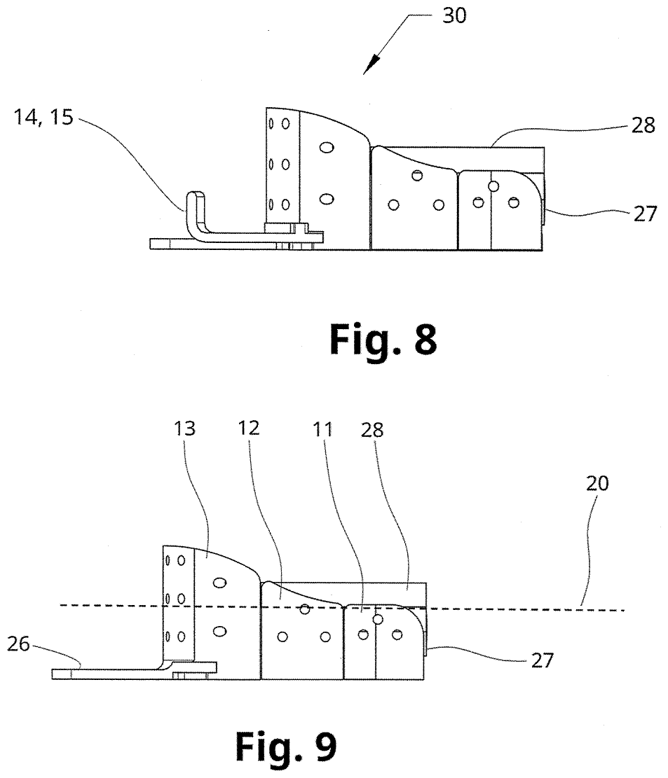

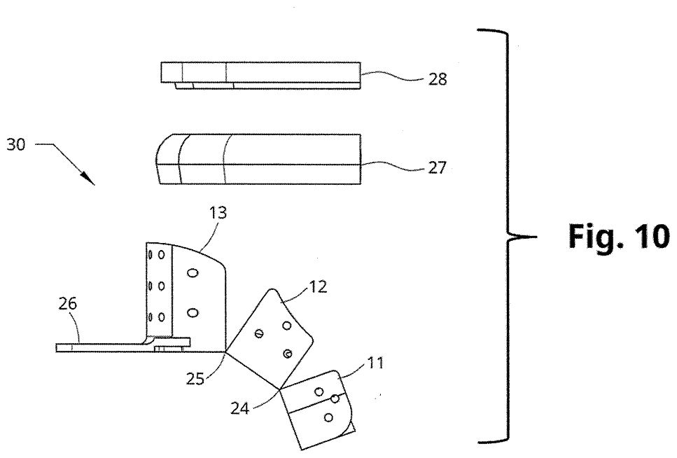

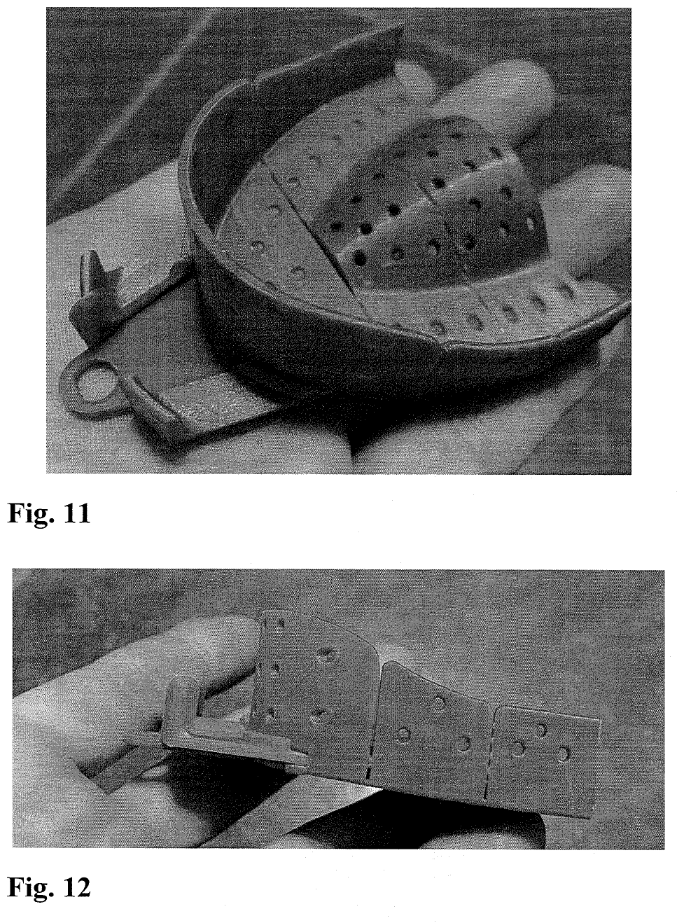

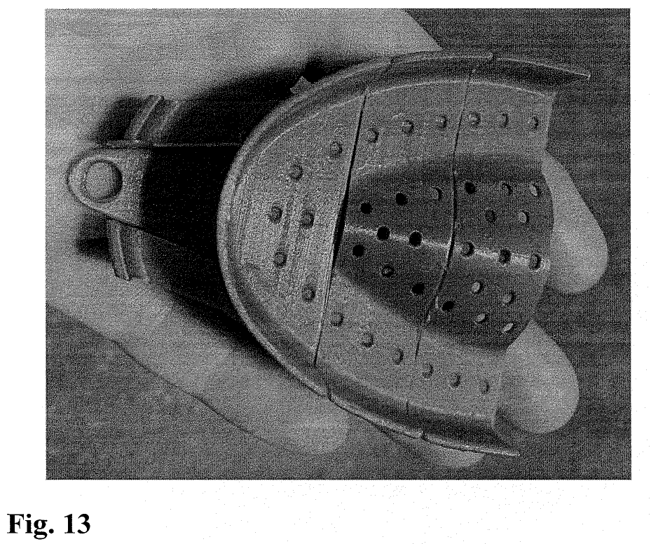

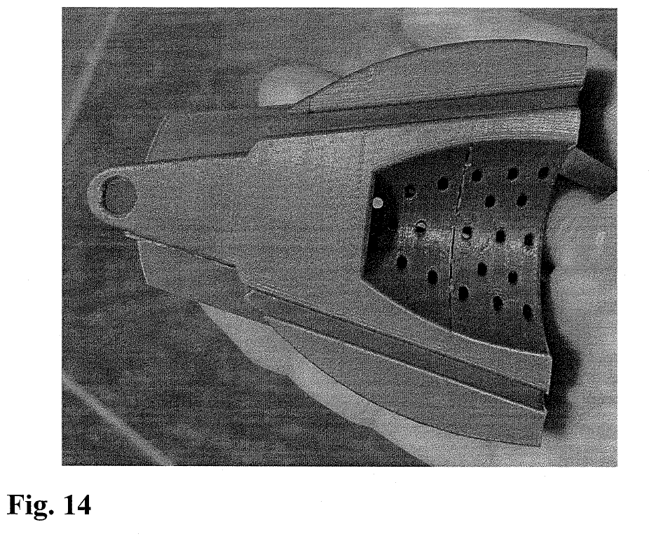

In use, the first tray 30 is provided to users as shown, with both stiffener bars 14 and 15 in place as shown in FIGS. 2-4 and 11-14. The user can readily use the device to take an impression of a patient's teeth and gums. As may be understood from FIG. 7, an impression material 27 is placed into the first tray 30. The first tray and impression material is pressed against the patients' dentition, allowing the impression material 27 to form around the patient's teeth and gums. When the impression material hardens, the tray 30 is removed from the patient's mouth. The impression material 27 sticks to the inside of the tray 30. Dental stone-forming material is mixed with a hardener and poured into the impression material 27, forming a dental stone model 28 of the patient's teeth and gums. The first tray 30 assembly with impression material 27 and stone model 28 is shown in FIGS. 7 to 9. When the dental stone model 28 has hardened, the stiffener bars 14 and 15 are removed, as shown in FIGS. 9 and 10. The stiffener bars each have a handle 18 thereon to facilitate their removal from the slots 22, 23. At this point, the user can hold the tray 30 by the nose tab 26 and rotate segment 11 relative to segment 12, and segment 12 relative to segment 13, about the hinge lines 24, 25, thereby peeling the tray 30 away from the impression material 27. Then the impression material 27 can be peeled away in a conventional manner from the dental stone 28.

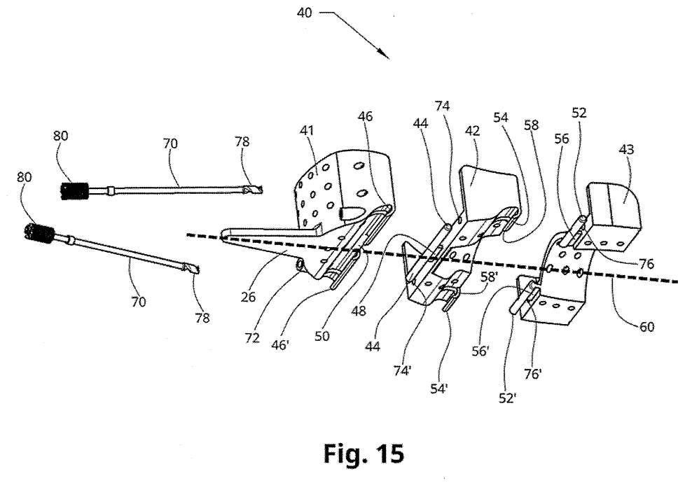

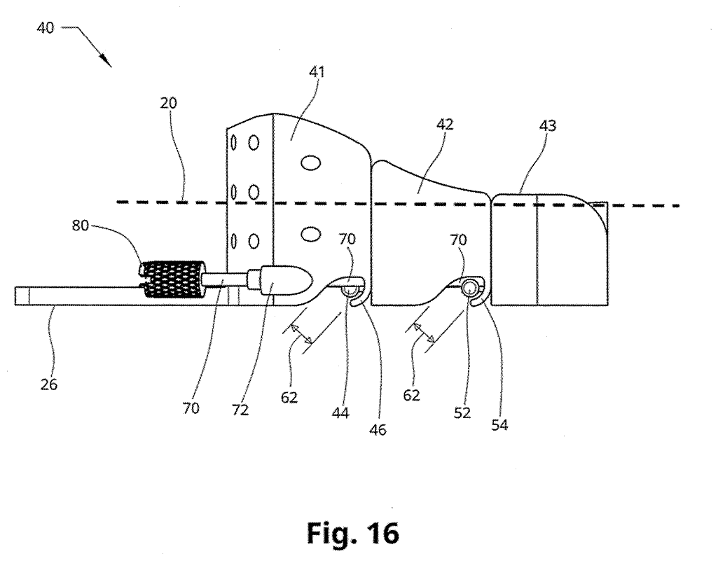

Referring now to FIGS. 15 and 16, the impression tray according to a second embodiment of the present invention, will be described.

The second impression tray 40 also has a tab 26 extending parallel to the occlusal plane 20 of the second tray 40, for easy manipulation thereof in and out of a patient's mouth. This second tray 40 also has three segments 41, 42, 43 that are hinged to each other in a similar way as in the first tray 30 previously described. As mentioned previously, the tray can alternatively be made with two segments or more than three segments. The hinge between segments 41 and 42 is made of hinge pin 44 on segment 42, fittingly engageable in two saddles 46, 46′ on segment 41. The hinge pin 44 is retained to segment 42 by a block 48. The saddles 46,46′ on segment 41 are separated by a gap 50. The width of gap 50 is a precise fit with the width of the block 48, so that the block 48 engages into the gap 50 in a precise sliding fit.

Similarly, the hinge between segments 42 and 43 is made of two aligned hinge pins 52, 52′ on segment 43, fittingly engageable in two saddles 54, 54′ on segment 42. The hinge pins 52, 52′ are retained to segment 43 by a respective block 56, 56′. The saddles 54, 54′ on segment 42 have inside shoulders 58, 58′ that are spaced apart an exact distance as between the blocks 56, 56′. The engagement of the hinge pins 52, 52′ into the saddles 54, 54′ and the fitting of blocks 56, 56′ between the saddles 54, 54′ provide a precise sliding fit.

The axes of hinge pins 44, 52, 52′ and saddles 46, 46′ and 54, 54′ are aligned perfectly parallel to each other, and are aligned precisely parallel with the plane on occlusal 20 of the second tray 40.

Referring particularly to FIG. 16, it will be appreciated that when the second tray 40 is articulated to remove the impression material 27 (shown elsewhere) and dental stone model 28 (shown elsewhere), the articulation of the segments 41, 42 and 43 is effected at precisely a right angle with the plane of occlusal 20. More importantly, because of the engagement of the block 48 with slot 50 and blocks 56, 56′ with shoulders 58, 58′, there is no possibility of lateral movement of one segment relative to the other. The lateral guiding of the segments prevents any deformation in the dental stone model 28 when the second tray is manipulated with force. This lateral guiding prevents any bending of the longitudinal axis 60 of the tray 40 along the occlusal plane.

Each saddle 46, 46′ and 54, 54′ has an open side 62 pointing diagonally frontward and downward. This open side 62 is wide enough to let the hinge pins 44, 52, 52′ pass by. Because of these open sides 62, segment 43 can be separated from segment 42, and segment 42 can be separated from segment 41. During the removal of a stone model 28 from the second tray 40, the tray can be taken apart in segments to facilitate the removal of the impression material 27 and the stone model 28 from the tray. It is understood that the size of open side 62 is not limited to being larger than the diameter of the hinge pins 44, 52, 52′. In some cases, open side 62 is by design slightly smaller than the diameter of hinge pins 44, 52 and 52′, creating a snap fit for the hinge pins 44, 52 and 52′.

During the forming of an impression of a dental structure, the segments 41,42, 43 of the second tray 40 are held tight together by two tension rods 70. The rods extend through sockets 72, 72′ through segment 41, through orifice 74, 74′ in segment 42, and through connectors 76, 76′ in segment 43. Each tension rod 70 has a formed end 78, such as threaded segment, a helix, a half-turn lock or otherwise, to connect the formed end 78 with connectors 76, 76′ in segment 41. The free end of each tension rod 70 has a thumb knob 80 thereon.

The alignment of both tension rods 70 defines an acute angle therebetween centered on the longitudinal axis 60 of the second tray 40. When tension is applied to the tension rods, the segments 41,42 and 43 are pulled together to create a seamless form inside the tray, wherein any distortion of the longitudinal axis 60 of the second tray 40 is prevented.

In a third embodiment of the present invention, the entire third tray itself or one or more segments thereof, or the impression material, are dissolvable in a solution. This embodiment allows a greater degree of freedom in the manipulation of a tray during the release of a dental model. Examples of suitable materials include reversible or irreversible hydrocolloids (like agar), reversible polymers (linear, branched, crosslinked, or a combination thereof), sodium alginate, cellulose, sugar, and cornstarch. Optionally, the tray and dried cast is dipped into a solution to aid in separating the poured cast from the impression material and the tray.

While two embodiments of the present invention have been illustrated in the accompanying drawings and three embodiments have been described hereinabove, it will be appreciated by those skilled in the art that various modifications, alternate constructions, and equivalents may be employed without departing from the spirit and scope of the invention. Therefore, the above description and the illustrations should not be construed as limiting the scope of the invention, which is defined by the appended claims.

1. A dental impression tray comprising:
a) a plurality of adjoining segments forming an entirety thereof, each of the segments having slots therein;
b) stiffening elements removably extending through the slots in said segments for selectively locking the segments together during the use thereof for taking a dental impression, and selectively unlocking the segments for removing a stone model from the tray;
wherein said stiffening elements are configured for pulling said segments against each other and for increasing the moment of inertia of the tray to resist bending stress.

2. A dental impression tray comprising:
a) a plurality of adjoining segments forming an entirety thereof, each of the segments having slots therein;
b) a hinge means between each of said adjoining segments allowing movement of said segments relative to each other; and
c) stiffening elements removably fitly sliding in said segment slots for selectively locking the segments together, during the use of the tray for taking a dental impression, and selectively unlocking the segments for removing a stone model from the tray;
wherein said stiffening elements and said slots increase the moment of inertia of the tray to resist bending stress.

3. A dental impression tray comprising:
a) a plurality of adjoining segments forming an entirety thereof, each of the segments having slots therein;
b) a hinge means between each of said adjoining segments allowing movement of said segments relative to each other;
c) stiffening elements removably extending through the slots in said segments for selectively locking the segments together during the use thereof for taking a dental impression, and selectively unlocking the segments for removing a stone model from the tray wherein each of said hinges has engaging shoulders there along, said shoulders being configured for preventing a movement of said hinge along an axis thereof,
and wherein said stiffening elements are configured for pulling said segments against each other and for increasing the moment of inertia of the tray to resist bending stress.

4. The dental impression tray of claim 1, wherein at least one segment of said tray is dissolvable in a solution.

5. The dental impression tray of claim 4, wherein said dissolvable segment is formed from a material selected from the group consisting of: reversible and or irreversible hydrocolloids, reversible polymers (linear, branched, crosslinked or a combination thereof), sodium alginate, cellulose, sugar and cornstarch.

6. The dental impression tray of claim 1, wherein said tray is formed from a material selected from the group consisting of: plastic, metal, silicone, and rubber.

7. The dental impression tray of claim 1, wherein said stiffening elements are stiffening bars.

8. The dental impression tray of claim 7, wherein said stiffening bars have a cross-sectional T-shape.

9. The dental impression tray of claim 1, wherein said stiffening elements are tension rods which are tightened using a method selected from the group consisting of: threads, a helix, and a half-turn lock, a friction fit, a detent, a separate nut, or a cotter pin.

10. The dental impression tray of claim 1, wherein said tray comprises three segments.

11. The dental impression tray of claim 2, wherein at least one segment of said tray is dissolvable in a solution.

12. The dental impression tray of claim 11, wherein said dissolvable segment is formed from at least one material selected from the group consisting of: reversible hydrocolloids, irreversible hydrocolloids, sodium alginate, cellulose, reversible polymers, sugar and cornstarch.

13. The dental impression tray of claim 2, wherein said tray is formed from a material selected from the group consisting of: plastic, metal, silicone, and rubber.

14. The dental impression tray of claim 2, wherein said stiffening elements are tension rods which are tightened using a method selected from the group consisting of: threads, a helix, a half-turn lock, a friction fit, a detent, a separate nut, or a cotter pin.

15. The dental impression tray of claim 2, wherein said tray comprises three segments.

16. The dental impression tray of claim 3, wherein at least one segment of said tray is dissolvable in a solution.

17. The dental impression tray of claim 16, wherein said dissolvable segment is formed from at least one material selected from the group consisting of: reversible hydrocolloids, irreversible hydrocolloids, sodium alginate, cellulose, reversible polymers, sugar and cornstarch.

18. The dental impression tray of claim 3, wherein said tray is formed from a material selected from the group consisting of: plastic, metal, silicone, and rubber.

19. The dental impression tray of claim 3, wherein said stiffening elements are tension rods which are tightened using a method selected from the group consisting of: threads, a helix, a half-turn lock, a friction fit, a detent, a separate nut, or a cotter pin.

20. The dental impression tray of claim 3, wherein said tray comprises three segments.

21. The dental impression tray of claim 7, wherein said stiffener bars are tapered between 0° and 5° degrees along their respective lengths.

22. The dental impression tray of claim 7, wherein said slots are tapered between 0° and 5° degrees along their respective lengths.

23. The dental impression tray of claim 7, wherein the stiffener bars have a handle that clips into a segment, limiting the axial movement of the stiffener bars.
